(19) United States
(12) Patent Application Publication
(10) Pub. No.: US 2002/0176637 A1
(43) Pub. Date: Nov. 28, 2002

(54) Image processing method of following the deformation of an organ which is deformable over time

(76) Inventor: Cyril Allouche, Paris (FR)

Correspondence Address: U.S. Philips Corporation, 580 White Plains Road, Tarrytown, NY, 10591, US

(21) Appl. No.: 10/055,360

(22) Filed: Jan. 23, 2002

(30) Foreign Application Priority Data
Jan. 23, 2001 (FR) 0100881

(51) Int. Cl. G06K 9/36

(52) U.S. Cl. 382/288

(57) ABSTRACT

The invention relates to a processing method for images of a sequence of at least two images IM(t1) and IM(t2) having a surface which is representative of an organ or a part of an organ which is deformable over time and which is referred to as the organ surface, said surface including characteristic points, denoted marked points MP, which correspond to each other from one image to another in the sequence. The method includes a step CALC of calculation of the positions of the marked points MP(t1) and MP(t2), a step DET of determining parameters of an explicit mathematical function f(t1/t2) of the deformation of the organ observed between the two images. Said determining step is carried out from positions of a group MP′ of marked points in the two images. Moreover, the invention proposes practical tools to follow the deformation and its possible pathologic abnormalities.

The invention relates to a method of processing images belonging to a sequence of at least two images having a surface representing an organ or a part of an organ which is deformable over time and referred to as the organ surface, said surface including characteristic points, denoted marked points, which correspond to each other from one image to another in the sequence. This invention also relates to an image processing apparatus for implementing the method described above.

The invention finds its application in the field of medical image processing. The method is in particular applicable to organ images marked by magnetic resonance spatial modulation. This marking is visible on the images in the form of marking lines with points of intersection. The marking lines deform following the deformation of the organ. Said intersection points are then chosen as marked points since the matches between these points from one image to another are easily detected.

An organ image processing method marked by magnetic modulation with a view to quantifying the deformation of the organ is already known from the state of the art through the publication by Matthias Stuber et al. entitled “Quantification of the local heartwall motion by magnetic resonance myocardial tagging”. In this document, the points of intersection between the marking lines are determined by approximation algorithms based on a calculation of potential (“snakes”). In addition, this method uses a mean of the angles with respect to the center of gravity in order to quantify the rotation and contraction.

This method has drawbacks. First of all, the approximation algorithms based on a calculation of potential mentioned above do not allow a precise determination of the positions of the marking lines. Next, the method used by Stuber et al. following the determination of the marking lines is concerned only with a calculation of the path of the points step by step from paths of the marked points without having a global approximation of the deformation of the organ. The method used utilizes a mean of the angles with respect to the center of gravity for quantifying the rotation and contraction. The result is imprecise since it is subject to local errors in determining the marking lines and mathematically incorrect. In addition, this method cannot be automated.

One object of the invention is to provide a method of quantifying the deformation of the organ without suffering the local errors in determining the marking lines.

In fact, a method in accordance with the introductory paragraph is characteristic according to the invention in that it comprises steps of:

calculating positions of the marked points on at least two images, successive or not,

determining parameters of an explicit mathematical expression of the deformation of the organ or part of the organ observed between the two images from positions in a set of marked points on the two images, said set of marked points containing the marked points present on the surface of the organ or at least the marked points present on a part of the surface of the organ.

Regularization by an explicit mathematical expression for quantifying the deformation replaces the approximation by interpolation of the movement at each point, which is the method chosen in the document of the state of the art cited. The parameters of the expression are obtained from a set of marked points containing the marked points present on the surface of the organ or at least the marked points present on part of the surface of the organ. The mathematical expression obtained is then at least valid at any point on this surface or on said part of this surface. This approximation estimates a movement in the very strict sense of least squares with an explicit mathematical regularization. This regularization corrects the noise.

The invention is applied particularly to the heart, which amongst other things exhibits deformation in rotation and contraction. In a particular implementation of the invention, the mathematical expression is defined in a polar reference frame. The center of the reference frame is defined either automatically by calculating a center of gravity, or manually by a user. The center of gravity can then be defined as the center of gravity of the image or as the center of gravity of a surface defined, for example, by segmentation of the image. The position of this center can be approximate without appreciably affecting the determination of the mathematical expression. The mathematical expression will advantageously be chosen as being able to express deformations close to those expected for the organ being imaged. Thus the similarities can take account of the rigid deformation of the heart. In a preferred implementation of the invention, the mathematical expression is derived from the expression of a similarity, that is to say, is of the form, in the centered reference frame of center o:

$$f ( z ) = \vert z - o \vert \underbrace{( {\sum }_{{k = - N}_{k \neq 0}}^{N} {a}_{k} {e}^{ik θ} )}_{{f}_{o} ( θ )} + d , θ = arg ( z - o ) , ( {a}_{k} ) ε {C}^{2 N + 1}$$

This particular expression in fact makes it possible to quantify the true deformation of the heart with great fidelity.

This expression does not however make it possible to take account of the dependency of the deformation in terms of radius. In a particular embodiment, a corrective term which is a function of the radius and the polar angle is introduced into the mathematical expression of the deformation, said corrective term including parameters determined a posteriori from the determination of the first mathematical expression using a set of marked points on the two images. The regularization process then takes place in two steps: calculation of the aₖ values and then radial correction. These two steps are iterated until there is convergence, obtained in general after 2 or 3 iterations.

The mathematical expression obtained includes a certain number of parameters representing rigid deformations and elastic deformations of the organ. Knowledge of these parameters is important for the detection of abnormalities in the behavior of the organ by a practitioner. In particular, equipment or apparatus for implementing the method according to the invention comprises means of extracting the parameters from the mathematical expression of the deformation corresponding to rigid deformations and means of displaying the change in these parameters during the sequence.

The practitioner may also wish to know the deformation of a particular structure of the organ, for example a structure visible on the image in the form of a contour. In a particular embodiment, the image processing apparatus comprises means for defining a structure per unit length of an image in the sequence, means for applying the mathematical expression of the deformation to said structure per unit length and means for displaying the deformation undergone by said structure per unit length.

The structure per unit length can be defined automatically or be defined manually by the practitioner, on one of the images in the sequence. The deformation of this structure can be followed from one image to the following one in the sequence by means of the mathematical expression determined according to the invention. The structure per unit length can thus follow a contour which is visible on the image and represents a physical structure of the organ (for example, the epicardium or the endocardium), applying the deformation then makes it possible to follow the movements of the physical structure. The structure per unit length may also make it possible to effect a segmentation of the image, and said segmentation will then be followed throughout the sequence with the following of the deformation of the structure per unit length. Such a segmentation may make it possible to define the surface on which the mathematical expression is determined: the quantity of calculations is then reduced and the determination of the mathematical expression is more precise since it can be carried out on more restricted surfaces. The structure per unit length may be any structure included not strictly on the surface on which the mathematical expression of the deformation is defined.

The invention will be further described with reference to examples of embodiment shown in the drawings to which, however, the invention is not restricted.

FIG. 1 depicts a diagram of an image processing method according to the invention,

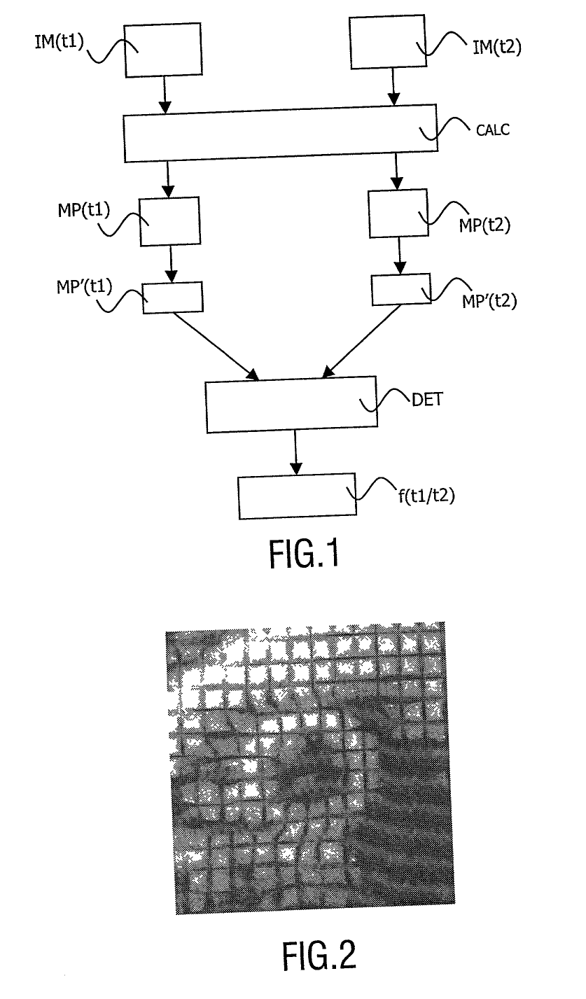

FIG. 2 presents a CSPAMM image of a heart, said image belonging to a sequence of images and being taken after the magnetization pulse,

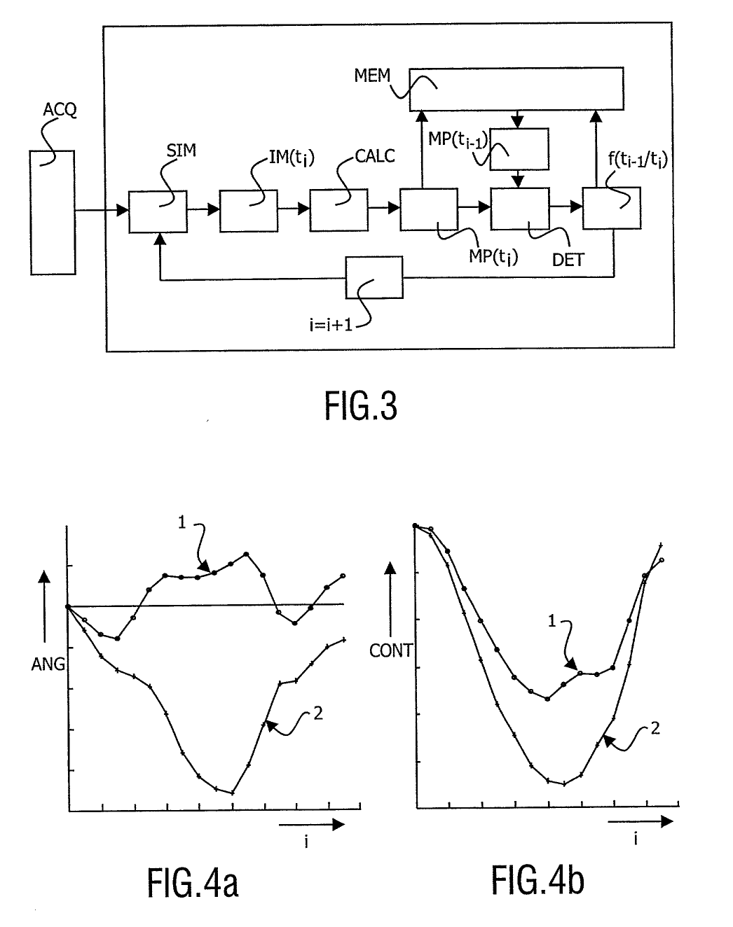

FIG. 3 depicts an image processing apparatus according to a particular embodiment of the invention,

FIGS. 4a and 4b depict respectively the change over time in the rotation and contraction parameters during three image sequences, each being taken at different places on the heart,

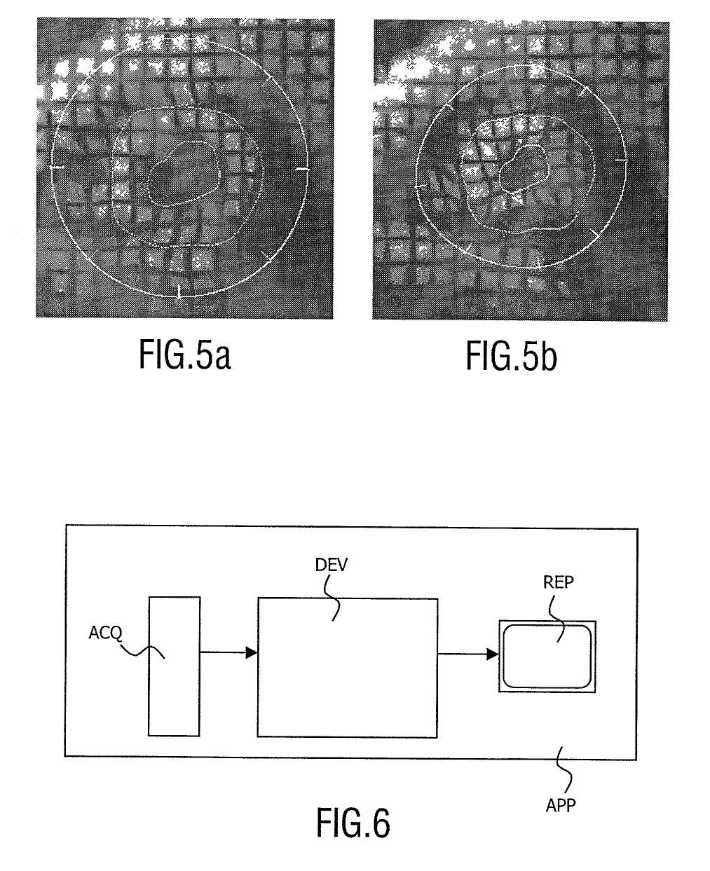

FIG. 5 depicts the following of the deformation of a circle to which the given expression of the deformation during the sequence is applied, and

FIG. 6 depicts an apparatus for capturing and processing images according to the invention.

FIG. 1 depicts a diagram of an image processing method according to the invention. Said method is applicable to images belonging to an image sequence of at least two images IM(t1) and IM(t2) taken at two times t1 and t2 of an organ or part of an organ which is deformable over time. Said organ or said part of the organ being visible on the images in the form of a surface called the surface of the organ, said surface including characteristic points whose correspondences are determined from one image to another in a sequence, said characteristic points are denoted marked points. Said organ or said part of an organ may, for example, be marked by magnetic resonance spatial modulation. Hereinafter, the invention is described more particularly in the case of this marking by magnetic resonance spatial modulation.

The technique of marking by magnetic resonance spatial modulation includes in particular the SPAMM and CSPAMM techniques for obtaining images in which the marking is visible on the images along marking lines which may be of different geometries when they are generated in the organ (straight lines, curves etc). Said marking lines deform whilst following the material deformation of the organ. In the images obtained by means of the techniques mentioned above, the lines corresponding to the spatial magnetization minima are dark lines and can easily be located.

Magnetic resonance spatial modulation is in general used by taking series of images of the organ marked at successive and regular times. These series of images are referred to as image sequences and the deformation of the organ is observed by means of the deformation of the marking lines which constitute a kind of frame attached to the organ. Said frame may have various aspects: parallel straight lines, a grid consisting of straight lines in two directions etc. A technique known as ‘Slice Following’ makes it possible to follow the deformation of a section of the organ even if the plane of this section moves in a direction substantially perpendicular to this plane during the sequence.

In the case of a periodic deformation of the organ, several sequences of images of the same organ taken for similar successive deformations show the same deformation on each similar image, that is to say, sampled at the same time within the deformation period. In this case, the similar images can be combined so that the frames of the two images are visible on the new image resulting from the combination. In this way a new image sequence is defined by effecting this combination on all the images in the sequence. This new sequence in general contains more information than the original more simple sequences.

According to the sequence acquisition times, which depend on the marking chosen, it may be advantageous either to work on a single image sequence of the organ marked with a complex marking or to work on a combination of several image sequences (generally two) of the organ marked for each occasion with a simple marking, said combination defining a new sequence used next in the image processing method according to the invention.

FIG. 2 presents an image of a heart, said image belonging to an image sequence and being taken approximately 9 ms after the magnetization pulse. Two sets of parallel lines corresponding to light intensity minima are observed, the parallel lines in one set being perpendicular to the parallel lines in the other set. The image sequence from which this example is taken thus has marking lines in two distinct directions and may thus be the result either of a direct acquisition of an image sequence of the organ marked in both directions or the combination of two acquisitions of sequences, each of the two sequences being marked in one of the two directions.

Two types of marking lines may be used in a method according to the invention. In FIG. 2, the marking lines corresponding to intensity minima, that is to say, to magnetic resonance minima, can easily be located. The marking lines corresponding to intensity maxima and corresponding to magnetic resonance maxima are, however, also detectable, even if they are less easy to detect. For example, by derivation from the image intensity profile it is possible to locate the lines corresponding to the magnetization maxima. The use of these two types of marking lines increases the information on the image since the marking frame is closer together: the number of intersection points between marking lines and therefore the number of marked points is higher.

With regard to the quality of the photographs of a sequence, the CSPAMM technique makes it possible notably to obtain a persistent contrast on a sequence. This is in particular useful in the case where the marking lines corresponding to the magnetic resonance maxima are used, the persistent contrast helping with the localization of the intensity minima.

The image processing method according to the invention processes images where marked points for which it is possible to establish correspondences from one image to the other are present. In the case of magnetic resonance spatial modulation, the marking lines are such that there are points of intersection between several marking lines. It is easy to establish matches from one image to another for these points of intersection, which are hereinafter referred to as marked points MP. They may be points of intersection between marking lines of any form and may be directly visible on the marking frame or be visible only after a combination of several sequences, giving a new image sequence.

The method according to the invention (FIG. 1) includes a first step CALC of calculating the positions of the marked points. This may, in the example of magnetic resonance spatial modulation, be effected by the use of the method described in patent application PHF000116 included herein by reference. In this patent application, points which are candidates for belonging to a given marking line are detected before means of predicting the movement of the marking line are used to identify the marking line and the points belonging to it and before an equation for the line is calculated. Whilst the equations for the marking lines have been determined, calculating the positions of the marked points is easy. The marked points MP(t1) and MP(t2) are the points for which a correspondence is established from one image IM(t1) to the image IM(t2), the two times t1 and t2 being able to be successive or not in the image sequence and t1 being able to be either subsequent to or prior to t2.

The method according to the invention next includes a step DET of determining an explicit mathematical expression f of the deformation of the organ or of the part of the organ observed between the image IM(t1) and IM(t2) from a set MP′ of marked points whose positions are defined by MP′(t1) on the image IM(t1) and MP′(t2) on the image IM(t2). Said sets MP′ are included not strictly in the sets MP of marked points and include the marked points present on the surface of the organ or at least those present on part of this surface. The parameters of the mathematical expression are generally determined by least squares approximation from the positions of the marked points whose positions are known on the two images and therefore whose movement is known between t1 and t2. The mathematical expression may, for example, be a similarity which takes account of the rigid deformations.

In a particular embodiment, the mathematical expression of the deformation is defined in the complex plane. The deformation can be defined in a polar reference frame. In the particular case, in which the organ is a heart, it is easy to define a center positioned approximately at the center of gravity of the surface of the organ as seen on the image.

In the preferred embodiment of the invention, the mathematical expression is derived from a similarity which can be written in a form relating to a point o chosen in any manner, but generally chosen as being approximately the center of gravity of the surface observed:

ƒ(z)=|z-o|(ae^{iθ})+d,θ=arg(z-o).

The expression of the similarity is modified by introducing a Fourier series into the expression in order to take account of deformations which are more elastic than a simple similarity:

$$f ( z ) = \vert z - o \vert \underbrace{( {\sum }_{{k = - N}_{k \neq 0}}^{N} {a}_{k} {e}^{ik θ} )}_{{f}_{o} ( θ )} + d , θ = arg ( z - o ) , ( {a}_{k} ) ε {C}^{2 N + 1}$$

This expression takes account of a global semi-elastic deformation in a centered reference frame. It is defined by 2×(2N+1)+2 real parameters which are defined from marked points of the set MP′. These values are in general overevaluated since there are more marked points in MP′ than parameters. This is in particular the case when the marking lines corresponding to the magnetic resonance maxima are used, the number of points of intersection between the lines then being high. The overevaluation of the parameters makes it possible to smooth the noise.

In the case of the heart, the endocardium is notably more contractile than the epicardium and consequently the more the center of the myocardium is approached the greater the magnitude of the radial movement. A corrective term which is a function of the radius and the polar angle is advantageously added a posteriori to the determination of the explicit mathematical expression f in order to add a dependency in terms of radius. This corrective term is also determined using the positions of the marked points MP′ on the two images but this determination is effected after the determination of the parameters aₖ of the deformation f(z).

In an advantageous implementation, the corrective term is defined by angular sectors s of the image and is of the form:

$$γ ( r , θ ) = {\sum }_{s} ( {γ}_{s} ( r ) \frac{{Π}_{k \neq s} ( θ - {θ}_{k} )}{{Π}_{k \neq s} ( {θ}_{s} - {θ}_{k} )} ) .$$

The term γₛ(r) is a polynomial in terms of r independent of θ defined on the angular sector s of the image according to the positions of the marked points on the angular sector s on the two images. The Lagrange polynomial interpolator is then used to take account of the dependency in terms of θ, θₛ being the center angle of the angular sector s.

If the corrective term were determined at the same time as the function f, there would exist a multiplicity of writing of the set except if the function f were constrained. However, f gives a mathematical expression of the global deformation. The corrective term represents the physiological behavior rather than the kinematic deformation.

Overall, the elasticity of the mathematical expression is controlled by the choice of N, the Fourier order (N=3 is generally sufficient) and, where the corrective term is introduced, by the number of angular sectors considered for the approximation of the corrective term and the choice of the degree of the polynomial γₛ.

FIG. 3 depicts image processing equipment according to a particular embodiment of the invention. This equipment is in relationship with means ACQ of acquiring sequences SIM of X images. This equipment includes the means CALC of calculating the positions of the marked points on two images, successive or not, and means DET of determining parameters of an explicit mathematical expression of the deformation of the organ or of the part of the organ observed between the two images from positions of a set of marked points on the two images, the said set of marked points containing the marked points present on the surface of the organ and at least the marked points present on part of this surface.

In the particular embodiment depicted in FIG. 3, the method described in the FIG. 1 for two images, successive or not, is iterated on the set of successive images IM(tᵢ) of the image sequence SIM. After an initialization for a counter initialized to i=0, where the positions of the marked points MP(0) are calculated and stored in the memory MEM, the process described below is initiated with i=1. This initialization is not explicitly depicted in the figure since it is the particular case of the general scheme where i=0, where f is the null function and where MP(tᵢ₋₁)=MP(0).

An image IM(tᵢ) is extracted from the sequences of images SIM. The positions of the marked points MP(tᵢ) are calculated by calculation means CALC. These positions are stored in a memory MEM and are supplied to means DET of determining a mathematical expression of the deformation. The positions of a set of marked points MP′(tᵢ₋₁) of the previous image IM(tᵢ₋₁) are extracted from the memory MEM and supplied to the means DET for determining the expression of the deformation f(tᵢ₋₁; tᵢ). In the embodiment depicted in FIG. 3, the mathematical expression of the deformation is then stored in the memory MEM and the counter is incremented to i=i+1.

The iteration of the determination of the deformation on a sequence SIM makes it possible to evaluate the parameters of the deformation and their change over time. The mathematical expression of the deformation includes amongst other things the rigid contraction and rotation parameters which are included in the complex parameter a₁. Knowledge of these parameters and of the changes in them makes it possible to extract them from the expression and to trace them as a function of time. FIGS. 4a and 4b depict respectively, in two graphs, the change over time as a function of i of the rotation ROT and of the contraction CONT extracted from a₁ for two image sequences IM(i), each being taken for two different points on the heart: the base (curve 1) and the apex (curve 2). The extraction of these parameters and the display thereof require knowledge within the capability of experts. These graphs are particularly useful for the practitioner, who can thus visualize the overall deformation of the organ during the sequence. In the example of the heart, the practitioner, by means of this tool, visualizes the overall rigid deformation of the heart and can detect abnormalities therein.

In accordance with FIG. 5, it is also possible to visualize the global deformation with its rigid and elastic components by applying a circle to the part of the mathematical expression independent of the radius. In the preferred embodiment, the mathematical expression applied is of the form:

$$f ( z ) = \vert z - o \vert \underbrace{( {\sum }_{{k = - N}_{k \neq 0}}^{N} {a}_{k} {e}^{ik θ} )}_{{f}_{o} ( θ )} + d , θ = arg ( z - o ) , ( {a}_{k} ) ε {C}^{2 N + 1}$$

The visualization of the deformation of the circle is, for the practitioner, a powerful and user-friendly tool for detecting abnormalities of the cardiac deformation. An example of this visualization of the deformation is presented in FIGS. 5a and b.

FIG. 6 depicts an image acquisition apparatus APP, the said apparatus comprising means ACQ of acquiring sequences of at least two images of an organ or of a part of an organ caused to deform over time, the said organ or the said part of the organ being visible in the images in the form of a surface referred to as the surface of the organ, the said surface including characteristic points whose correspondences are determined from one image to another in the sequence, means REP of visual representation of these images, which can comprise a video mode to follow the deformation during the sequence, and an image processing apparatus DEV as described previously.

1. A method of processing images belonging to a sequence of at least two images having a surface representing an organ or a part of an organ which is deformable over time and referred to as the organ surface, said surface including characteristic points, denoted marked points, which correspond to each other from one image to another in the sequence, said method comprising steps of:
calculating positions of the marked points on at least two images, successive or not,
determining parameters of an explicit mathematical expression of the deformation of the organ or part of the organ observed between the two images from positions in a set of marked points on the two images, said set of marked points containing the marked points present on the surface of the organ or at least the marked points present on part of the surface of the organ.

2. An image processing method as claimed in claim 1, characterized in that said organ is marked by magnetic resonance spatial modulation, said marking being visible on the images in the form of marking lines, said marking lines deforming whilst following the deformation of the organ and being such that there exist points of intersection between said marking lines, said points of intersection being the marked points.

3. An image processing method as claimed in one of claims 1 and 2, characterized in that the expression of the deformation is defined in the complex plane.

4. An image processing method as claimed in claim 3, characterized in that said mathematical expression of the deformation is of the form
$$f ( z ) = \vert z - o \vert \underbrace{( {\sum }_{{k = - N}_{k \neq 0}}^{N} {a}_{k} {e}^{ik θ} )}_{{f}_{o} ( θ )} + d , θ = arg ( z - o ) , ( {a}_{k} ) ε {C}^{2 N + 1}$$

5. An image processing method as claimed in one of claims 3 and 4, characterized in that a corrective term which is a function of the radius and of the polar angle is introduced into the mathematical expression of the deformation, said corrective term including parameters determined a posteriori from the determination of the first mathematical expression from a set of marked points on the two images.

6. An image processing apparatus having means for receiving or generating images, said images belonging to a sequence of at least two images having a surface representing an organ or a part of an organ which is deformable over time and referred to as the organ surface, said surface including characteristic points, denoted marked points, which correspond to each other from one image to another in the sequence, said equipment comprising means for:
calculating positions of the marked points on at least two images, successive or not,
determining parameters of an explicit mathematical expression of the deformation of the organ or part of the organ observed between the two images from positions in a set of marked points on the two images, said set of marked points containing the marked points present on the surface of the organ or at least the marked points present on part of the surface of the organ.

7. An image processing apparatus as claimed in claim 6, characterized in that said organ is marked by magnetic resonance spatial modulation, said marking being visible on the images in the form of marking lines, said marking lines deforming whilst following the deformation of the organ and being such that there exist points of intersection between said marking lines, said points of intersection being the marked points.

8. An image processing apparatus as claimed in claim 7, for implementing a method as claimed in one of claims 3 to 5.

9. An image processing apparatus as claimed in one of claims 7 and 8, comprising means for iterating the method described for two images, successive or not, in claim 1, on all the successive images in the image sequence.

10. An image processing apparatus as claimed in claim 9, comprising means for extracting the parameters of the mathematical expression of the deformation corresponding to rigid deformations and means for visualizing the changes in these parameters during the sequence.

11. An image processing apparatus as claimed in one of claims 7 to 10, comprising means for defining a structure per unit length, means for applying the mathematical expression of the deformation to said structure per unit length and means for visualizing the deformation undergone by said structure per unit length.

12. An image processing apparatus as claimed in claim 11, characterized in that said structure per unit length is a circle and in that the means for applying the mathematical expression of the deformation to said structure per unit length apply only the dependent part of the polar angle to the circle.

13. An image processing apparatus as claimed in claim 11, characterized in that said structure per unit length is any structure per unit length defined on one of the images of the sequence and in that the deformation is followed over all the successive images of the sequence using means for applying the mathematical expression of the deformation to said structure per unit length applying, at each point on the structure per unit length, the mathematical expression of the deformation valid at this point.

14. An image capture and processing apparatus, said apparatus comprising means for acquiring a sequence of at least two images representing a representative surface of an organ or a part of an organ which is deformable over time and referred to as the organ surface, said surface including characteristic points, denoted marked points, which correspond to each other from one image to another in the sequence, means for visual representation of these images, an image processing apparatus as claimed in one of claims 7 to 13.
